(19) United States
(12) Patent Application Publication
(10) Pub. No.: US 2026/0145705 A1
(43) Pub. Date: May 28, 2026

(54) SYSTEMS AND METHODS FOR AUTONOMOUS VEHICLE MINIMAL RISK MANEUVER IDENTIFICATION AND EXECUTION

(71) Applicant: Torc Robotics, Inc., Blacksburg, VA (US)

(72) Inventors: Akshay Pai Raikar, Austin, TX (US); Joseph R. Fox-Rabinovitz, Austin, TX (US)

(21) Appl. No.: 18/962,642

(22) Filed: Nov. 27, 2024

(51) Int. Cl. B60W 60/00; B60W 50/02

(52) U.S. Cl. CPC B60W 60/0015; B60W 50/0205; B60W 50/0225

(57) ABSTRACT

An autonomy computing system of an autonomous vehicle includes a memory device and a processor, the processor including a minimal risk maneuver (MRM) module. The MRM module includes a plurality of executable MRM generators, each MRM generator associated with a respective MRM, and a task handler programmed to provide input data to and receive output data from the MRM generators. The processor is programmed to receive a notification of vehicle component failure, and, in response, input the input data to at least one MRM generator. The processor is also programmed to execute the at least one MRM generator with the input data to generate the output data, identify, based on the output data, an output MRM to be performed, based on a hierarchical relationship of the MRMs associated with the plurality of MRM generators, and transmit instructions to control components of the autonomous vehicle to implement the output MRM.

### TECHNICAL FIELD

The field of the disclosure relates generally to autonomous vehicle control and, more specifically, to the identification and execution of one or more minimal risk maneuvers (MRMs) for an autonomous vehicle.

### BACKGROUND OF THE INVENTION

In the field of autonomous vehicle control, how to control the autonomous vehicle in the event of a component or system failure needs to be determined. These vehicles include features, such as autonomy computing systems, that enable the vehicle to identify various types of failures or the magnitude thereof. The autonomous vehicle also identifies one or more necessary remedial actions. For example, certain degraded capabilities may necessitate the calibration of sensors or other automatic or online adjustments, whereas more significant failures may necessitate repairs or other interventions that require the autonomous vehicle to stop.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed autonomy computing system of an autonomous vehicle includes at least one memory device storing computer-executable instructions and at least one processor including a minimal risk maneuver (MRM) module. The MRM module includes a plurality of executable MRM generators, each MRM generator associated with a respective MRM to be performed by the autonomous vehicle, and a task handler programmed to provide input data to and receive output data from the plurality of MRM generators. The at least one processor is programmed, by the computer-executable instructions to receive, at the task handler, a notification of component failure of at least one component of the autonomous vehicle, and, in response to receiving the notification, input, via the task handler, the input data to at least one MRM generator of the plurality of MRM generators. The at least one processor is also programmed to execute the at least one MRM generator with the input data to generate the output data, and, based on the output data from the at least one MRM generator, identify, via the task handler, an output MRM to be performed by the autonomous vehicle, based on a hierarchical relationship of the MRMs associated with the plurality of MRM generators. The processor is further programmed to transmit instructions to one or more control components of the autonomous vehicle to implement the output MRM.

In another aspect, the disclosed autonomous vehicle includes a plurality of control components and an autonomy computing system having at least one memory device storing computer-executable instructions and at least one processor including a minimal risk maneuver (MRM) module. The MRM module includes a plurality of executable MRM generators, each MRM generator associated with a respective MRM to be performed by the autonomous vehicle, and a task handler programmed to provide input data to and receive output data from the plurality of MRM generators. The at least one processor is programmed, by the computer-executable instructions to receive, at the task handler, a notification of component failure of at least one component of the autonomous vehicle, and, in response to receiving the notification, input, via the task handler, the input data to at least one MRM generator of the plurality of MRM generators. The at least one processor is also programmed to execute the at least one MRM generator with the input data to generate the output data, and, based on the output data from the at least one MRM generator, identify, via the task handler, an output MRM to be performed by the autonomous vehicle, based on a hierarchical relationship of the MRMs associated with the plurality of MRM generators. The processor is further programmed to transmit instructions to one or more of the control components to implement the output MRM.

In yet another aspect, the disclosed method of executing a minimal risk maneuver (MRM) for an autonomous vehicle is implemented using an autonomy computing system including at least one processor and at least one memory device. The at least one processor is programmed to perform the method, including receiving, at a task handler executable by the autonomy computing system, a notification of component failure of at least one component of the autonomous vehicle. The method also includes inputting, in response to receiving the notification and via the task handler, the input data to at least one MRM generator of a plurality of MRM generators executable by the autonomy computing system, and executing the at least one MRM generator with the input data to generate the output data. The method further includes identifying, based on the output data from the at least one MRM generator, via the task handler, an output MRM to be performed by the autonomous vehicle, based on a hierarchical relationship of the MRMs associated with the plurality of MRM generators, and transmitting instructions to one or more control components of the autonomous vehicle to implement the output MRM.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRA WINGS

The following drawings form part of the present specification and are included to further demonstrate certain aspects of the present disclosure. The disclosure may be better understood by reference to one or more of these drawings in combination with the detailed description of specific embodiments presented herein.

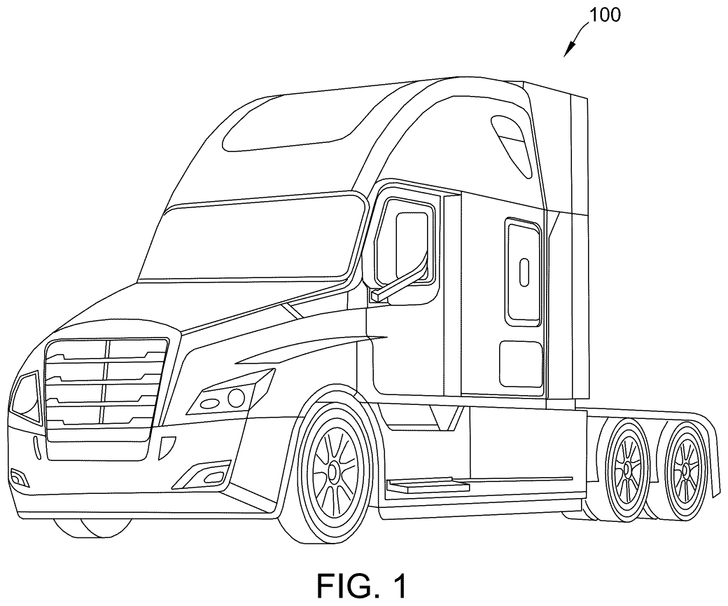

FIG. 1 is a schematic diagram of an autonomous vehicle;

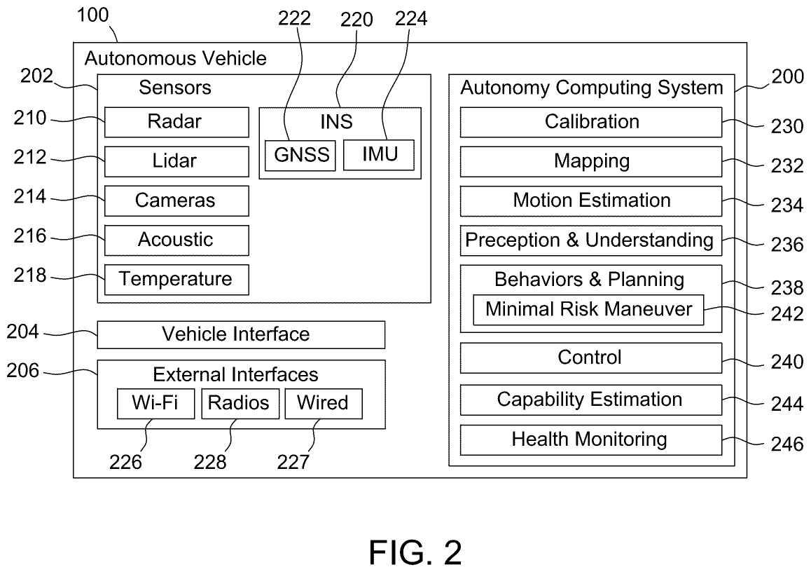

FIG. 2 is a block diagram of an autonomous vehicle;

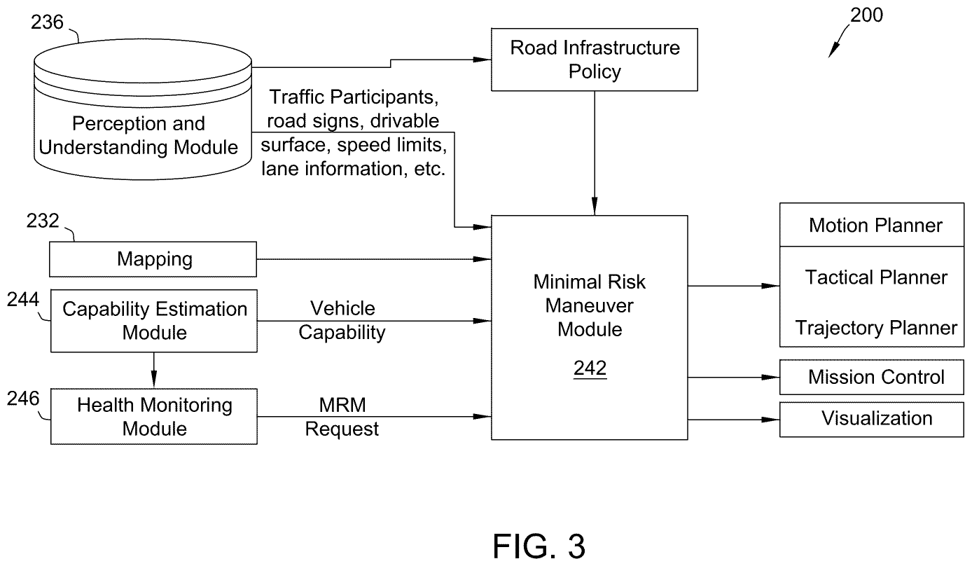

FIG. 3 is a block diagram of an autonomy computing system of the autonomous vehicle shown in FIGS. 1 and 2, including a minimal risk maneuver (MRM) module; and

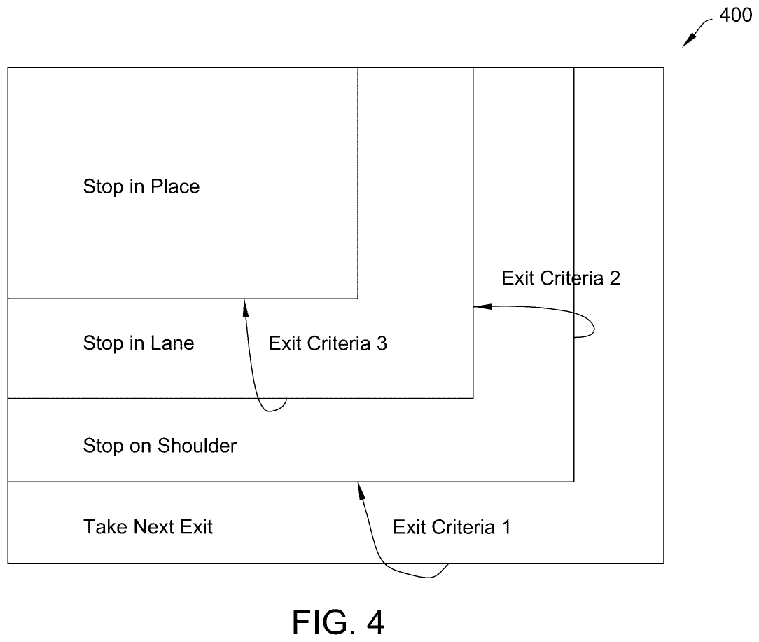

FIG. 4 is a schematic diagram illustrating a hierarchical and nested relationship between minimal risk maneuvers;

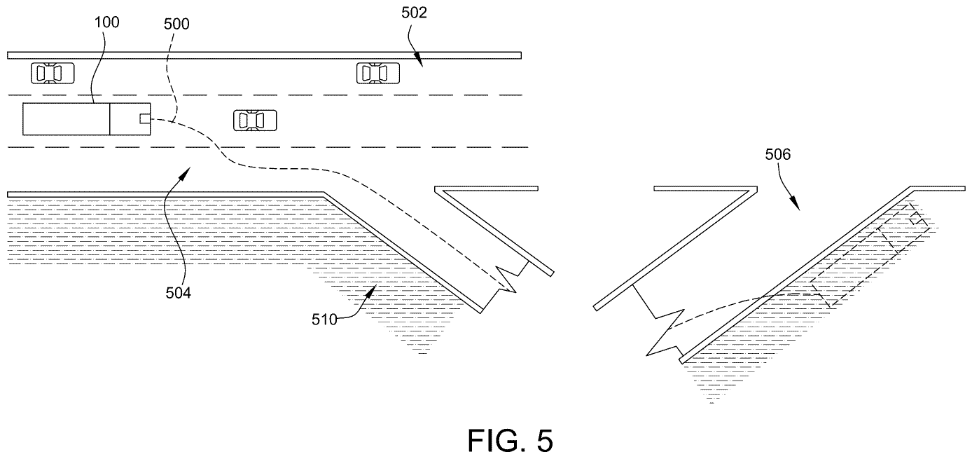

FIG. 5 is a schematic diagram of a first MRM performed by an autonomous vehicle;

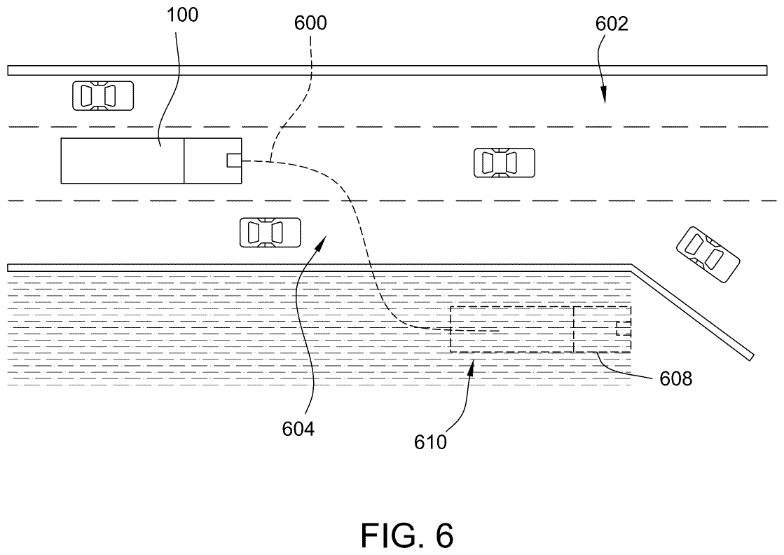

FIG. 6 is a schematic diagram of a second MRM performed by an autonomous vehicle;

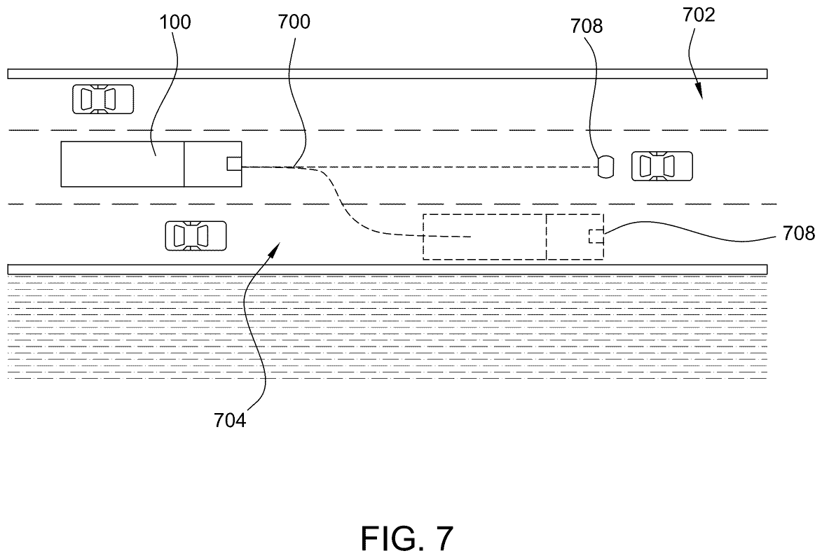

FIG. 7 is a schematic diagram of a third MRM performed by an autonomous vehicle;

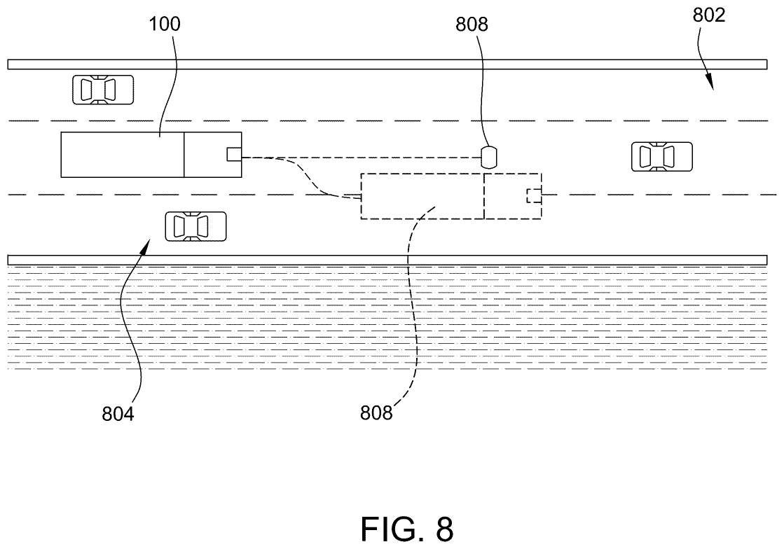

FIG. 8 is a schematic diagram of a fourth MRM performed by an autonomous vehicle;

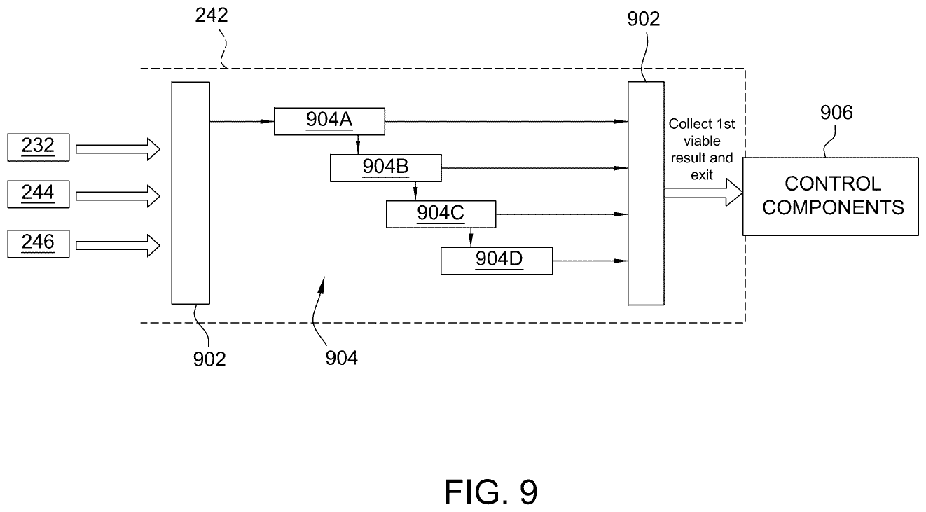

FIG. 9 is a schematic diagram of the MRM module, illustrating sequential execution of MRM generators;

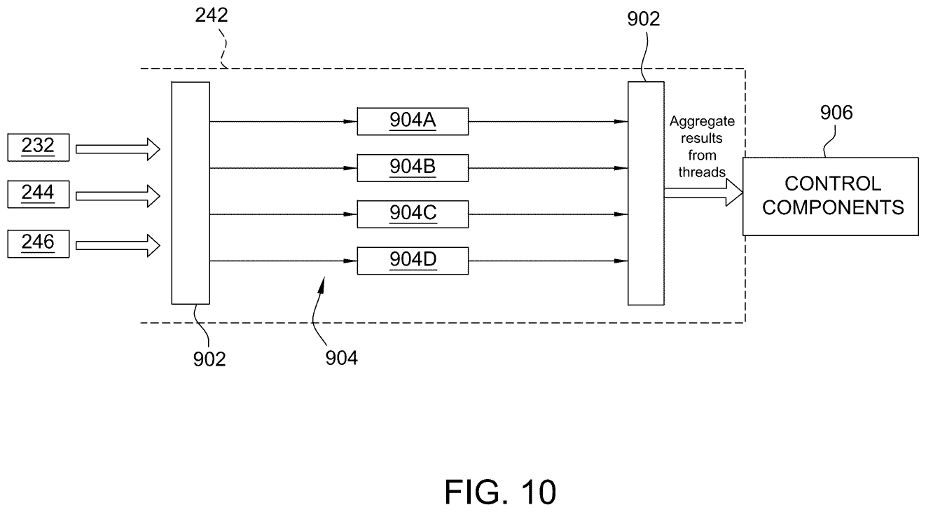

FIG. 10 is another schematic diagram of the MRM module, illustrating parallel execution of MRM generators;

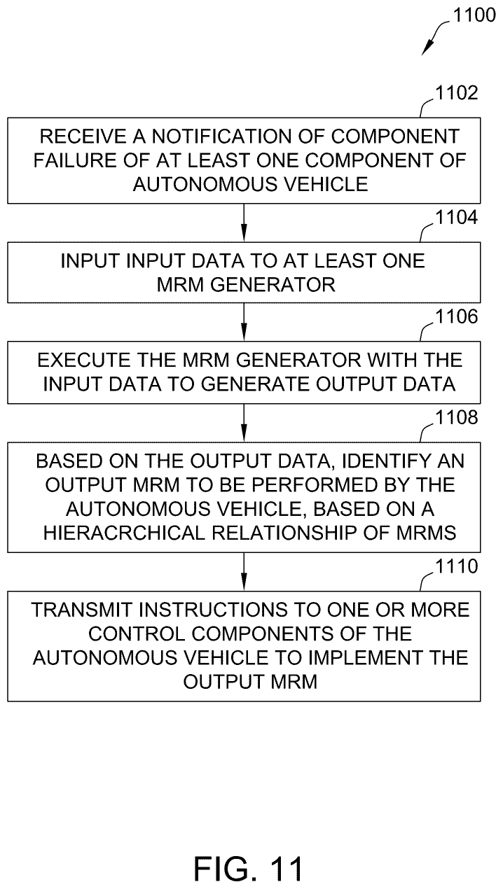

FIG. 11 is a flow diagram of a method of executing an MRM for an autonomous vehicle; and

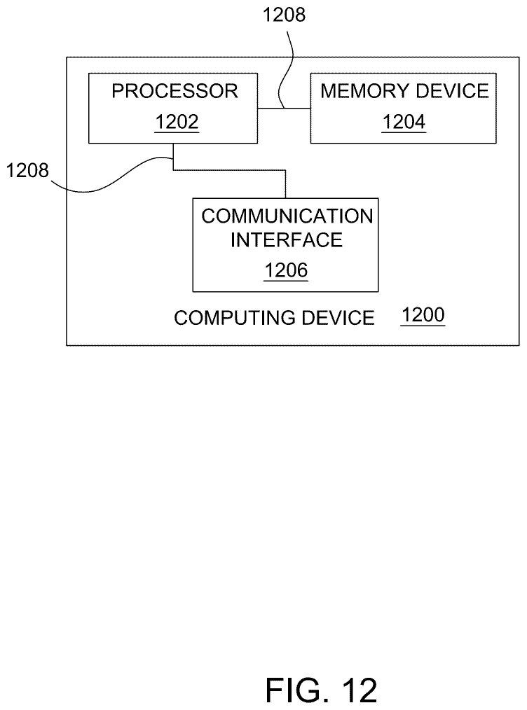

FIG. 12 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The present disclosure is directed to an autonomous vehicle and autonomy computing system thereof, having a minimal risk maneuver (MRM) module configured to identify and execute one or more minimal risk maneuvers (MRMs) in the event of component failure. As used here, component failure, or system failure, may refer to the degradation in capability or complete loss of function of one or more components or systems on the autonomous vehicle, where such failure impacts an ability of the component or the autonomous vehicle to function under normal operating conditions or to function safely. MRMs are maneuvers or actions by the autonomous vehicle to reduce risks to the autonomous vehicle, other vehicles, people, animals, or structures on the road when the autonomous vehicle experiences a component failure.

In the example embodiments, a plurality of MRMs are defined relative to operation of the vehicle. The defined MRMs include (1) stop on on-ramp, (2) stop on shoulder, (3) stop in lane, and (4) stop in place. These MRMs are listed in order of preference, or level of risks involved. For example, stopping on an on-ramp outside of highway traffic is preferred to (e.g., is less risky than) stopping on a shoulder beside highway traffic, whereas stopping in place (e.g., upon loss of a functionality that requires an immediate stop) is considered the least preferred or most risky MRM.

It should be recognized that alternative or additional MRMs may be defined for the autonomous vehicle, such as any of: (i) take exit and stop on a shoulder of on-ramp, (ii) take exit and stop on on-ramp biased or directed towards the shoulder, (iii) stop on wide shoulder away from active travel lanes, (iv) stop on any available shoulder, (v) stop in right-most travel lane, biased or directed towards the shoulder, (vi) stop in the right-most travel lane, (vii) slow down to a stop in the current traveling lane, and (viii) stop in place. Further additional or alternative MRMs may include (ix) take exit and stop on a shoulder of off-ramp, or (x) exit onto off-ramp and bias toward shoulder. Notably, each of these listed MRMs can be generalized to the four MRMs (1) through (4) listed above.

Broadly, the MRM module takes in data related to the component failure and the current capabilities of the autonomous vehicle to perform any of the defined or available MRMs. The most preferred or least risky MRM that is viable for or within the capabilities of the autonomous vehicle is selected and executed. The selected MRM to be executed is referred to herein as the output MRM.

For example, the MRM module may receive estimates related to an amount of driving time or distance, a trajectory, an amount of fuel remaining for the autonomous vehicle, traffic conditions, road topography (e.g., curves, grades, rough concrete), or a speed limit or average operating speed along the current section of road. The MRM module also determines or identifies the status of various sensors, control components, and the like. Based on this information, which may be generally referred to as “capability estimation data,” the MRM module determines the least risky or most preferred MRM that the autonomous vehicle is capable of completing. The MRM module identifies this MRM as the output MRM and instructs the autonomous vehicle (e.g., control components) to complete the output MRM and stop the autonomous vehicle. Once the autonomous vehicle is stopped, any remedial actions can be initiated. For example, recovery procedures may be initiated to diagnose and/or repair the failure or retrieve the autonomous vehicle. In one example embodiment, once the MRM module is activated, the functionality thereof cannot be exited or superseded. That is, autonomous vehicle 100 must be controlled to come to a halt, according to one of the MRMs.

FIG. 1 is a schematic diagram of an autonomous vehicle 100, FIG. 2 is a block diagram of autonomous vehicle 100 shown in FIG. 1, and FIG. 3 is a block diagram of an autonomy computing system 200 of autonomous vehicle 100 shown in FIGS. 1 and 2. Specifically, in the example embodiment, autonomous vehicle 100 includes autonomy computing system 200, as well as sensors 202, a vehicle interface 204, and external interfaces 206.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein, the term “autonomous” includes fully autonomous, semi-autonomous, or having any level of autonomy.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various control components of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, BLUETOOTH, etc.).

In some embodiments, external interfaces 206 may be configured to communicate with an external network via a wired connection 227, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200, shown in FIGS. 2 and 3, is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, a minimal risk maneuver (MRM) module 242, a capability estimate module 244, and a health monitoring module. In the illustrated embodiment, MRM module 242 is embodied as a “sub-module” within behaviors and planning module 238. In any alternative embodiment, MRM module 242 may be embodied separately or may be embodied within another module, such as, but not limited to, perception and understanding module 236. Likewise, capability estimate module 244 or health monitoring module 246 may be embodied within another module, such as, but not limited to, motion estimation module 234, behaviors and planning module 238, or MRM module 242, or may be embodied separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

With reference to FIGS. 2 and 3, in the example embodiment, health monitoring module 246 monitors the health and capability of various components and systems of autonomous vehicle 100. For example, health monitoring module 246 receives various status codes from components and systems of autonomous vehicle 100. When a component failure is detected, based on the received status codes (or, in some cases, a lack of receiving a status code from an offline or unresponsive component), health monitoring module 246 transmits a request or notification (or some other message or data) to MRM module 242. This notification identifies the detected component failure to MRM module 242. In some embodiments, health monitoring module 246 receives data from capability estimation module 244 and uses that capability estimation data for generation of the notification.

Capability estimation module 244 computes or estimates a capability of autonomous vehicle 100 at the time of or following the notification. For example, capability estimate module 244 may estimate or identify an amount of driving time or distance left available to autonomous vehicle 100, a trajectory, an amount of fuel remaining for autonomous vehicle 100, traffic conditions, road topography (e.g., curves, grades, rough concrete), or a speed limit or average operating speed along the current section of road. Capability estimate module 244 also determines or identifies the status of various sensors 202, control components, and the like. Capability estimate module 244 may communicate with any other modules of autonomy computing system 200 or components of autonomous vehicle 100 to perform capability estimates. Capability estimate module 244 transmits its computations to MRM module 242 for further processing. In some embodiments, capability estimate module 244 estimates the capability of autonomous vehicle 100 and transmits the capability estimate data to health monitoring module 246. For example, capability estimate module 244 incorporates the identified component failure into its capability estimation and returns the estimate back to health monitoring module 246. Health monitoring module 246 may then incorporate this estimate into the notification before transmitting the notification to MRM module 242.

MRM module 242 receives the notification from health monitoring module 246 and capability estimates from capability estimate module 244 and processes these data to identify and select one MRM of a plurality of MRMs to execute at autonomous vehicle 100. MRM module 242 is configured to incorporate additional or alternative information into its processing. For example, MRM module 242 receives mapping information from mapping module 232, or receives road and environment information (e.g., traffic participant, road signs, drivable surface, speed limits, lane information, etc.) from perception and understanding module 236.

MRM module 242 processes the data to select the MRM to be executed—the output MRM—as well as a trajectory of autonomous vehicle 100 to complete the output MRM. MRM module 242 transmits instructions to one or more of behaviors and planning module 238, control module 240, and control components of autonomous vehicle 100 to execute the output MRM and bring autonomous vehicle 100 to a halt. Upon safely stopping at the determined location, autonomous vehicle 100 or autonomy computing system 200 can run various self-diagnostics, and/or remote assistance can take over autonomous vehicle 100 to run diagnostics and dispatch technicians/rescue vehicles as needed.

Turning to FIG. 4, a schematic diagram 400 is depicted, illustrating a hierarchical relationship between MRMs. When identifying and selecting an MRM to be executed, various factors are reviewed (e.g., by capability estimate module 244 and/or MRM module 242), such as speed limits, traffic conditions, road grade and curvatures, remaining fuel, and sensor integrity. MRM module 242 identifies which MRMs are viable for autonomous vehicle 100 and, from those MRMs, selects an MRM that is the most preferred, or the least risky, as the output MRM to be executed by the autonomous vehicle 100.

Diagram 400 depicts MRMs having a hierarchical order of preference or safety, from (1) exit and stop on on-ramp, (2) stop on shoulder, (3) stop in lane, and (4) stop in place. The MRMs are individually schematically depicted in FIGS. 5-8.

Specifically, FIG. 5 depicts a first MRM, stop on on-ramp. This first MRM may be referred to as a safest MRM, a most preferred MRM, etc., and the designation “first” is made relative to the above-described hierarchical relationship of the defined MRMs. As shown, to execute this first MRM, autonomous vehicle 100 is navigated (when able) along a first MRM path 500, from its current location, across one or more lanes 504 of a road 502, onto an on-ramp 506, to its final location or position 508, at which autonomous vehicle 100 is controlled to come to a halt. In the example embodiment of the first MRM, final position 508 is on a shoulder 510 on-ramp 506.

FIG. 6 depicts a second MRM, stop on shoulder. The designation “second” is made relative to the above-described hierarchical relationship of the defined MRMs. As shown, to execute this second MRM, autonomous vehicle 100 is navigated (when able) along a second MRM path 600, from its current location, across one or more lanes 604 of a road 602 if there are one or more lanes 604 between a shoulder 610 and a lane 604T along which autonomous vehicle 100 is traveling, onto shoulder 610 of road 602, to its final location or position 608, at which autonomous vehicle 100 is controlled to come to a halt.

FIG. 7 depicts a third MRM, stop in lane. The designation “third” is made relative to the above-described hierarchical relationship of the defined MRMs. As shown, to execute this third MRM, autonomous vehicle 100 is navigated (when able) along a third MRM path 700, from its current location, to its final location or position 708, at which autonomous vehicle 100 is controlled to come to a halt. In the example embodiment, final position 708 is located within a drivable lane 704 of a road 702, which may be, in some embodiments, a right-most drivable lane that autonomous vehicle 100 can reach within its capability (which may or may not be a right-most drivable lane of road 702).

FIG. 8 depicts a fourth MRM, stop in place. The designation “fourth” is made relative to the above-described hierarchical relationship of the defined MRMs. This fourth MRM may be considered the least preferable or most risky MRM, and may be selected as the MRM for execution when autonomous vehicle 100 has lost substantial capability (e.g., braking capability, steering capability, etc.). As shown, to execute this fourth MRM, autonomous vehicle 100 is stopped at or near its current location. For example, a final position 808 of autonomous vehicle 100 may be identified and autonomous vehicle 100 is controlled to come to a halt thereat. As another example, autonomous vehicle 100 may be in the process of navigating to a final location and may be controlled to halt in its current position (or as fast as possible), which may or may not be within a lane 804 of a road 802.

It should be recognized that alternative or additional MRMs may be defined for autonomous vehicle 100, such as any of: (i) take exit and stop on a shoulder of on-ramp, (ii) take exit and stop on on-ramp biased or directed towards the shoulder, (iii) stop on wide shoulder away from active travel lanes, (iv) stop on any available shoulder, (v) stop in right-most travel lane, biased or directed towards the shoulder, (vi) stop in the right-most travel lane, (vii) slow down to a stop in the current traveling lane, and (viii) stop in place. Further additional or alternative MRMs may include (ix) take exit and stop on a shoulder of off-ramp, or (x) exit onto off-ramp and bias toward shoulder. Notably, each of these listed MRMs can be generalized to the four MRMs (1) through (4) listed above.

Referring back to FIG. 4, additionally, the relationship of these MRMs can also be considered nested, or having a recursive or cascading nature. That is, in the preferential or hierarchical order, the execution of each MRM inherently incorporates execution of the MRMs further down in the hierarchy. For instance, the first MRM (1), taking an exit and stopping on an on-ramp, culminates in autonomous vehicle 100 stopping on a road shoulder, which is the definition of the second MRM (2), stop on shoulder. Likewise, the second MRM (2) culminates in autonomous vehicle 100 stopping within a “lane” defined by the road's shoulder, which is the definition of the third MRM (3), stop in lane. Further, the third MRM (3) culminates in autonomous vehicle 100 stopping in place (i.e., a place within a lane), which is the definition of the fourth MRM (4), stop in place. This nested relationship simplifies the definition of the control instructions of the MRM and reduces the complexity of the minimal risk maneuver functionality of autonomous vehicle 100. Moreover, because are the functions nested within one another, this inherent relationship improves functionality of autonomous vehicle 100 when further loss of capability is detected or experienced during execution of an MRM. In such situations, the next MRM in the nested hierarchy is readily called for execution.

FIGS. 9 and 10 are schematic diagrams of MRM module 242, as shown in FIG. 2. In the example embodiment, MRM module 242 includes a task handler 902 and a plurality of minimal risk maneuver (MRM) generators 904.

Task handler 902 is configured to receive input data from, for example, mapping module 232, capability estimation module 244, and health monitoring module 246. Task handler 902 may receive data from other sources, such as other modules of autonomy computing system 200, sensors 202, etc. In the example embodiment, the input data includes a request or notification, such as a notification of component or system failure. The input data also includes capability information related to the operation of autonomous vehicle 100 and environmental information related to the environment in which autonomous vehicle 100 is operating; in some instances, this capability or environmental information may be received as part of the request or notification. Task handler 902 functions as an interface to and from MRM generators 904; that is, task handler 902 is further configured to transmit input data to MRM generators 904 and to receive output data therefrom. Task handler 902 executes MRM generators 904 based on and using the information provided to task handler 902 from the components outside MRM module 242. In particular, in the example embodiments, the process of transmitting such data to an MRM generator 904 causes execution of that MRM generator 904. Task handler 902 may be referred to as a monitoring component, because task handler 902 is configured to monitor a status of each MRM generator 904, which may include, for example, whether the MRM generator 904 is operating or what its output data arc.

MRM generators 904 are executable functions that are each associated with a respective MRM to be performed by autonomous vehicle 100. In the illustrated embodiment, a first MRM generator 904A is associated with the first MRM, exit and stop on on-ramp; a second MRM generator 904B is associated with the second MRM, stop on shoulder; a third MRM generator 904C is associated with the third MRM, stop in lane; and a fourth MRM generator 904D is associated with the fourth MRM, stop in place. Each MRM generator 904 consumes information (e.g., from task handler 902) related to the component/system failure, the capability of autonomous vehicle 100, the environment, etc., as described elsewhere herein. Each MRM generator 904 processes this information to determine if the particular MRM associated therewith is viable for autonomous vehicle 100 to execute.

In the example embodiment, the output from an MRM generator 904 is either (i) an error result, indicating that particular MRM is not viable for autonomous vehicle 100 (e.g., autonomous vehicle 100 cannot complete that particular MRM), or (ii) a maneuver success result, including an output data set reflecting the operations needed to complete that particular MRM. Task handler 902 receives this output data and proceeds as necessary, such as by executing another MRM generator 904 in the event of an error result, or, in the event of a maneuver success result, by generating control instructions for control components 906 to execute an output MRM and control autonomous vehicle 100 to come to a halt.

With reference to FIG. 9, an example embodiment of sequential execution of MRM generators 904 is illustrated. In this embodiment, MRM generators 904 execute or launch in a particular order that corresponds to the hierarchical and nested relationship of the MRMs. Specifically, task handler 902 provides input data to each MRM generator 904. First MRM generator 904A executes, or processes the input data to determine whether autonomous vehicle 100 is capable of completing the first MRM (exit and stop on on-ramp). First MRM generator 904A provides output data (e.g., an error result or a maneuver success result) to task handler 902 based on this processing. Regardless of that outcome, second MRM generator 904B executes or launches and performs its own processing on the input data, to determine whether autonomous vehicle 100 is capable of completing the second MRM (stop on shoulder). Second MRM generator 904B provides output data (e.g., an error result or a maneuver success result) to task handler 902 based on this processing. Regardless of that outcome, third MRM generator 904C executes or launches and performs its own processing on the input data, to determine whether autonomous vehicle 100 is capable of completing the third MRM (stop in lane). Third MRM generator 904C provides output data (e.g., an error result or a maneuver success result) to task handler 902 based on this processing. Regardless of that outcome, fourth MRM generator 904D executes or launches and performs its own processing on the input data, to determine whether autonomous vehicle 100 is capable of completing the fourth MRM (stop in place). In some instances, this determination is made based upon whether any control capabilities remain.

That is, in this embodiment of sequential operation, every MRM generator 904 is executed, and task handler 902 receives output data sequentially therefrom. Task handler 902 uses the output data from MRM generators 904 to identify the most optimal or preferred MRM that autonomous vehicle 100 is capable of completing, and generates and transmits control instructions to control components 906 accordingly. In the example embodiment, where an earliest-executed of MRM generators 904 outputs a maneuver success result, indicating that respective MRM is viable for autonomous vehicle 100, task handler 902 identifies that respective MRM as the output MRM and initiates execution of the output MRM. That is, because the higher-level or more optimal MRM generators 904 execute sequentially earlier, the first maneuver success result provided to task handler 902 necessarily corresponds to the most optimal or preferred MRM.

Under this paradigm of sequential operation, even if a new notification is received at task handler 902 with new information, the entire sequence of execution using the initial input data would still be completed before the new information could be processed by any MRM generator, which may result in latency in processing the notifications.

In an alternative embodiment, each MRM generator 904 after first MRM generator 904A executes only if the previous MRM generator 904 results an error result. Such conditional sequential operation may reduce latency, increasing the speed of the MRM identification process and conserving computing resources.

With reference to FIG. 10, an example embodiment of parallel execution of MRM generators 904 by task handler 902. In this embodiment, task handler 902 provides input data to MRM generators 904, and MRM generators 904 execute in parallel (e.g., substantially simultaneously) using the input data. Each MRM generator 904 performs its respective processing in parallel and provides its respective output data (e.g., an error result or a maneuver success result) to task handler 902. Task handler 902 uses the output data from MRM generators 904 to identify the most optimal or preferred MRM that autonomous vehicle 100 is capable of completing, and generates and transmits control instructions to control components 906 accordingly. In the example embodiment, task handler 902 receives these outputs substantially simultaneously or in no particular order. Therefore, task handler 902 is configured to determine the most optimal MRM viable for autonomous vehicle 100 when multiple maneuver successful result signals are received. For example, task handler 902 identifies the MRM generator 904 associated with the highest-level MRM and having returned a maneuver success result. Task handler 902 selects that MRM as the output MRM to be executed at autonomous vehicle 100. In some embodiments, task handler 902 may ignore or otherwise forego further processing of any error results.

Under this paradigm of parallel operation, task handler 902 may be completing various processing functions in parallel with MRM generators 904 or may receive a new notification. Task handler 902 may then feed new or updated information to all MRM generators 904.

In some embodiments, further or more severe component failure of autonomous vehicle 100 may occur after the execution of MRM generators 904 has been initiated or completed. Capability estimate module 244 may revise its computations and output updated capability estimation data. Health monitoring module 246 may receive the updated capability estimation data as well as other status data from other components of autonomy computing system 200 or autonomous vehicle 100. Health monitoring module 246 generates and transmits a second or updated notification to task handler 902. Task handler 902 processes the updated notification and inputs updated input data to MRM generators 904. MRM generators 904 execute using the updated input data and, in some instances, a previously selected output MRM may no longer be viable for autonomous vehicle 100. Task handler 902 receives output data from MRM generators 904 and identifies a different (e.g., lower-level) MRM as an updated output MRM. Task handler 902 may then generate and transmit updated control instructions for control components 906 to execute the updated output MRM at autonomous vehicle 100, controlling autonomous vehicle 100 to come to a halt sooner or within a shorter distance.

In some embodiments, additional or alternative paradigms of operation of MRM module 242 are available, and various paradigms may be implemented in any combination with other paradigms described herein.

For example, a stateful operation of MRM module 242 may be executed. Under this operation, there exists a variable that is populated to track the status of MRM generators 904 and, in some instances, a selected or executed MRM. This variable may be referred to as a “state variable.” In some embodiments, MRM module 242 stores a state variable for each MRM generator 904. In other embodiments, MRM module 242 stores a state variable whose value singularly represents operation of all MRM generators 904. Task handler 902 may query the state variable to determine which MRM generator(s) 904 are currently being executed at any point in time, whether an MRM generator 904 has output a result, and/or what the output data from the MRM generator 904 is. For example, the value of this state variable can be changed to reflect when a maneuver success result is output by any MRM generator(s) 904, triggering task handler 902 to initiate a corresponding output MRM. In some embodiments, MRM module 242 (e.g., task handler 902) may update the value of the state variable when a new or different output MRM is selected (according to any of the processing described herein) The state variable may have a temporary value and may be stored in a temporary memory of MRM module 242 (e.g., RAM), which is accessible to task handler 902 and MRM generators 904. In some embodiments, stateful operation may enable task handler 902 to more quickly identify which MRM generators 904 have been executed and/or the output data therefrom.

As another example, a stateless operation of MRM module 242 may be executed. Under this operation, there is no state variable. Rather, task handler 902 is informed by each MRM generator 904 of its respective status (e.g., when it is launched) and the output therefrom (e.g., error result or maneuver success result). In some embodiments, stateless operation may enable reduced data storage within MRM module 242 (compared to stateful operation).

In a further example, a reversible operation of MRM module 242 may be executed. Under this operation, execution of MRM generators 904 proceeds as described above (either sequentially or in parallel), and task handler 902 initiates execution of an output MRM. In some instances, task handler 902 receives a restoration notification, including data indicating that a previously unavailable functionality of autonomous vehicle 100 is now available, or that the capability of one or more components of autonomous vehicle 100 is otherwise “improved” relative to a previous state. In this embodiment, task handler 902 may provide updated input data to MRM generators 904, reflective of the restored operational state of autonomous vehicle 100. In some embodiments, if a more optimal (e.g., more preferred to less risky) MRM is now viable for autonomous vehicle 100, task handler 102 may select that more optimal MRM as an updated output MRM. Task handler 902 may generate revised or updated control instructions for execution of that updated output MRM. Stated differently, the execution may proceed “backwards,” relative to the hierarchical relationship of MRMs depicted in FIG. 4.

In some embodiments, a previously output error result may be used as a re-execution criterion. For example, if a more optimal (e.g., more preferred or less risky) MRM is now viable for autonomous vehicle 100 and the MRM generator 904 associated with the more optimal MRM has previously output an error result, task handler 902 may select that more optimal MRM as an updated output MRM. Task handler 902 may generate revised or updated control instructions for execution of that updated output MRM. Reversible operation may enable execution of an MRM by autonomous vehicle 100 that reduces the risk level of stopping. Additionally, reversible operation may improve flexibility and adaptability of MRM module 242 to varying situations.

As another example, an irreversible operation of MRM module 242 may be executed. Under this operation, execution of MRM generators 904 proceeds as described above (either sequentially or in parallel), and task handler 902 initiates execution of a selected output MRM. In these embodiments, however, regardless of whether autonomous vehicle 100 regains functionality, any more optimal or higher-level MRM will not be executed. Irreversible operation may reduce computing resources consumed by MRM module 242. For example, task handler 902 may recognize the restoration notification and, programmed under the irreversible operation paradigm, may ignore the notification and not input further data to MRM generators 904.

It should be readily understood that these paradigms may be used in many combinations, such as sequential-stateless-reversible, sequential-stateless-irreversible, sequential-stateful-reversible, sequential-stateful-irreversible, parallel-stateless-reversible, parallel-stateless-irreversible, parallel-stateful-reversible, or parallel-stateful-irreversible. Moreover, an MRM module 242 may be implemented under different combinations of the above paradigms under different conditions. That is, an MRM module 242 may be capable of operating under all of the above combinations.

Additionally, MRM module 242 may provide instructions or outputs to components in addition to control components 906. That is, MRM module 242 may initiate various other follow-on behaviors in conjunction with an MRM. For example, MRM module 242 may initiate a notification to nearby agencies of the failure, or a notification to nearby vehicles (e.g., using on-board vehicle-to-vehicle communications).

FIG. 11 is a flow diagram of an example method 1100 of executing a minimal risk maneuver (MRM) for an autonomous vehicle (e.g., autonomous vehicle 100, shown in FIG. 1). In the example embodiment, method 1100 is implemented using autonomy computing system 200, such as MRM module 242 (both shown in FIG. 2).

Method 1100 includes receiving 1102 a notification of component failure of at least one component of the autonomous vehicle. As described herein, receiving 1102 may be implemented using a task handler of MRM module 242 (e.g., task handler 902, shown in FIGS. 9 and 10). Method 1100 further includes inputting 1104, in response to receiving the notification the input data to at least one MRM generator of a plurality of MRM generators. As described herein, inputting 1104 may be implemented using a task handler of MRM module 242.

Method 1100 also includes executing 1106 at least one MRM generator of the plurality of MRM generators with the input data to generate the output data. Method 1100 further includes identifying 1108 (e.g., by the task handler), based on an output from the at least one MRM generator, an output MRM to be performed by the autonomous vehicle, based on a hierarchical relationship of the MRMs associated with the plurality of MRM generators. Method 1100 further includes transmitting 1110 (e.g., by the task handler) instructions to one or more control components of the autonomous vehicle to implement the output MRM.

Method 1100 may include additional, fewer, or alternative processes, including processes described elsewhere herein.

For example, in some embodiments, executing 1106 includes executing the plurality of MRM generators in a sequential order defined by the hierarchical relationship. In some embodiments, method 1100 also includes receiving (e.g., at the task handler) the output data from a first-executed MRM generator, the output data including a maneuver success result, and identifying 1106 includes identifying the output MRM as the MRM associated with the first-executed MRM generator. In some embodiments, method 1100 also includes receiving (e.g., by the task handler) the output data from a first-executed MRM generator, the output data including an error result, and receiving (e.g., by the task handler) the output data from a subsequent MRM generator, the output from the subsequent MRM generator including a maneuver success result. Identifying 1106 may include identifying the output MRM as the MRM associated with the subsequent MRM generator.

In some embodiments, executing 1104 includes executing the plurality of MRM generators in parallel. In some embodiments, method 1100 also includes receiving (e.g., at the task handler) the respective output data from each of the plurality of MRM generators, including at least one maneuver success result, and identifying 1106 the output MRM by identifying the output MRM as an MRM having a highest level in the hierarchical relationship and being associated with one of the plurality of MRM generators having output a maneuver success result. In some embodiments, method 1100 includes receiving a second notification of further component failure while executing the plurality of MRM generators, re-executing the plurality of MRM generators, updating, based on updated output data from the plurality of MRM generators, the output MRM to be performed by the autonomous vehicle, and transmitting instructions to the one or more control components of the autonomous vehicle to implement the updated output MRM.

In some embodiments, method 1100 includes receiving a restoration notification of restoration of component capability, re-executing at least one MRM generator of the plurality of MRM generators, receiving respective updated output data from the at least one MRM generator, and updating the output MRM to be implemented by the autonomous vehicle by replacing the output MRM with an updated output MRM having a higher level in the hierarchical relationship than an MRM being implemented by the autonomous vehicle.

In some instances, executing 1104 includes executing the plurality of MRM generators, and identifying 1106 includes identifying (e.g., by the task handler) the output MRM as the MRM associated with one of the plurality of MRM generators based on the output data in an order based on the hierarchical and nested relationship.

In some embodiments, method 1100 also includes storing a temporary value of a variable representing the output MRM being implemented, and, when a different output MRM is implemented at the autonomous vehicle, update the temporary value of the variable with a value corresponding to the different output MRM.

FIG. 12 is a block diagram of an example computing device 1200. Computing device 1200 includes a processor 1202 and a memory device 1204. Processor 1202 is coupled to memory device 1204 via a system bus 1208. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 1204 includes one or more devices that enable information, such as executable instructions or other data (e.g., sensor data), to be stored and retrieved. Moreover, memory device 1204 includes one or more computer readable media, such as, without limitation, dynamic random access memory (DRAM), static random access memory (SRAM), a solid state disk, or a hard disk. In the example embodiment, memory device 1204 stores, without limitation, application source code, application object code, configuration data, additional input events, application states, assertion statements, validation results, or any other type of data. Computing device 1200, in the example embodiment, may also include a communication interface 1206 that is coupled to processor 1202 via system bus 1208. Moreover, communication interface 1206 is communicatively coupled to data acquisition devices.

In the example embodiment, processor 1202 may be programmed by encoding an operation using one or more executable instructions and providing the executable instructions in memory device 1204. In the example embodiment, processor 1202 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) definition of a hierarchical relationship between MRMs, (b) definition of a nested relationship between MRMs, (c) reduced or simplified computation of an output MRM using the hierarchical and/or nested relationship, (d) use of a task handler for receiving input data to and handling output data from multiple MRM generators, providing a centralized control and management of the system, (e) combinations of operating paradigms to suit various applications or conditions, or (f) faster identification of an output MRM, leading to faster execution thereof.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle, the system comprising:
at least one memory device storing computer-executable instructions; and
at least one processor comprising a minimal risk maneuver (MRM) module, the MRM module comprising:
a plurality of executable MRM generators, each MRM generator associated with a respective MRM to be performed by the autonomous vehicle; and
a task handler programmed to provide input data to and receive output data from the plurality of MRM generators; and
wherein the at least one processor is programmed, by the computer-executable instructions to:
receive, at the task handler, a notification of component failure of at least one component of the autonomous vehicle;
in response to receiving the notification, input, via the task handler, the input data to at least one MRM generator of the plurality of MRM generators;
execute the at least one MRM generator with the input data to generate the output data;
based on the output data from the at least one MRM generator, identify, via the task handler, an output MRM to be performed by the autonomous vehicle, based on a hierarchical relationship of the MRMs associated with the plurality of MRM generators; and
transmit instructions to one or more control components of the autonomous vehicle to implement the output MRM.

2. The autonomy computing system of claim 1, wherein the at least one processor is further programmed to:
execute the at least one MRM generator of the plurality of MRM generators by executing the plurality of MRM generators in a sequential order defined by the hierarchical relationship.

3. The autonomy computing system of claim 2, wherein the at least one processor is further programmed to:
receive, at the task handler, the output data from a first-executed MRM generator, the output data including a maneuver success result; and
identify, via the task handler, the output MRM as the MRM associated with the first-executed MRM generator.

4. The autonomy computing system of claim 2, wherein the at least one processor is further programmed to:
receive, at the task handler, the output data from a first-executed MRM generator, the output data including an error result;
receive, at the task handler, the output data from a subsequent MRM generator, the output from the subsequent MRM generator including a maneuver success result; and
identify, via the task handler, the output MRM as the MRM associated with the subsequent MRM generator.

5. The autonomy computing system of claim 1, wherein the at least one processor is further programmed to:
execute the at least one MRM generator of the plurality of MRM generators by executing the plurality of MRM generators in parallel.

6. The autonomy computing system of claim 5, wherein the at least one processor is further programmed to:
receive, at the task handler, the respective output data from each of the plurality of MRM generators, including at least one maneuver success result; and
identify, via the task handler, the output MRM by identifying the output MRM as an MRM having a highest level in the hierarchical relationship and being associated with one of the plurality of MRM generators having output a maneuver success result.

7. The autonomy computing system of claim 5, wherein the at least one processor is further programmed to:
receive a second notification of further component failure while executing the plurality of MRM generators;
re-execute the plurality of MRM generators;
based on updated output data from the plurality of MRM generators, update the output MRM to be performed by the autonomous vehicle; and
transmit instructions to the one or more control components of the autonomous vehicle to implement updated output MRM.

8. The autonomy computing system of claim 1, wherein the at least one processor is further programmed to:
receive a restoration notification of restoration of component capability;
re-execute at least one MRM generator of the plurality of MRM generators;
receive respective updated output data from the at least one MRM generator; and
update the output MRM to be implemented by the autonomous vehicle by replacing the output MRM with an updated output MRM having a higher level in the hierarchical relationship than an MRM being implemented by the autonomous vehicle.

9. The autonomy computing system of claim 1, wherein each MRM generator, when executed, determines whether the autonomous vehicle is capable of performing the respective MRM.

10. The autonomy computing system of claim 1, wherein the MRM module defines a hierarchical and nested relationship of the MRMs associated with the plurality of MRM generators, wherein the at least one processor is further programmed to:
identify, by the task handler, the output MRM as the MRM associated with one of the plurality of MRM generators based on the output data in an order based on the hierarchical and nested relationship.

11. The autonomy computing system of claim 1, wherein the at least one processor is further programmed to:
store a temporary value of a variable representing the output MRM being implemented; and
when a different output MRM is implemented at the autonomous vehicle, update the temporary value of the variable with a value corresponding to the different output MRM.

12. An autonomous vehicle comprising:
a plurality of control components; and
an autonomy computing system comprising:
at least one memory device storing computer-executable instructions; and
at least one processor comprising a minimal risk maneuver (MRM) module, the MRM module comprising:
a plurality of executable MRM generators, each MRM generator associated with a respective MRM to be performed by the autonomous vehicle; and
a task handler programmed to provide input data to and receive output data from the plurality of MRM generators; and
wherein the at least one processor is programmed, by the computer-executable instructions to:
receive, at the task handler, a notification of component failure of at least one component of the autonomous vehicle;
in response to receiving the notification, input, via the task handler, the input data to at least one MRM generator of the plurality of MRM generators;
execute the at least one MRM generator with the input data to generate the output data;
based on the output data from the at least one MRM generator, identify, via the task handler, an output MRM to be performed by the autonomous vehicle, based on a hierarchical relationship of the MRMs associated with the plurality of MRM generators; and
transmit instructions to one or more of the plurality of control components to implement the output MRM.

13. The autonomous vehicle of claim 12, wherein the at least one processor is further programmed to:
execute the at least one MRM generator of the plurality of MRM generators by executing the plurality of MRM generators in a sequential order defined by the hierarchical relationship.

14. The autonomous vehicle of claim 12, wherein the at least one processor is further programmed to:
execute the at least one MRM generator of the plurality of MRM generators by executing the plurality of MRM generators in parallel.

15. The autonomous vehicle of claim 14, wherein the at least one processor is further programmed to:
receive a second notification of further component failure while executing the plurality of MRM generators;
re-execute the plurality of MRM generators;
based on updated output data from the plurality of MRM generators, update the output MRM to be performed by the autonomous vehicle; and
transmit instructions to the one or more control components of the autonomous vehicle to implement updated output MRM.

16. The autonomous vehicle of claim 12, wherein each MRM generator, when executed, determines whether the autonomous vehicle is capable of performing the respective MRM.

17. The autonomous vehicle of claim 12, wherein the MRM module defines a hierarchical and nested relationship of the plurality of MRM generators, wherein the at least one processor is further programmed to:
identify, by the task handler, the output MRM as the MRM associated with one of the plurality of MRM generators based on the output data in an order based on the hierarchical and nested relationship.

18. A method of executing a minimal risk maneuver (MRM) for an autonomous vehicle, the method implemented using an autonomy computing system including at least one processor and at least one memory device, the at least one processor programmed to perform the method comprising:
receiving, at a task handler executable by the autonomy computing system, a notification of component failure of at least one component of the autonomous vehicle;
in response to receiving the notification, inputting, via the task handler, the input data to at least one MRM generator of a plurality of MRM generators executable by the autonomy computing system;
executing the at least one MRM generator with the input data to generate the output data;
based on the output data from the at least one MRM generator, identifying, via the task handler, an output MRM to be performed by the autonomous vehicle, based on a hierarchical relationship of the MRMs associated with the plurality of MRM generators; and
transmitting instructions to one or more control components of the autonomous vehicle to implement the output MRM.

19. The method of claim 18, wherein said executing comprises executing the plurality of MRM generators in a sequential order defined by the hierarchical relationship.

20. The method of claim 18, wherein said executing comprises executing the plurality of MRM generators in parallel.
